(19) United States
(12) Patent Application Publication
(10) Pub. No.: US 2025/0279593 A1
(43) Pub. Date: Sep. 4, 2025

(54) ELECTRIC CABLE OR ELECTRIC WIRE PROVIDED WITH A PLUG CONTOUR FOR DIRECTLY PLUGGING INTO A MATING PLUG

(71) Applicants: Kromberg & Schubert Automotive GmbH & Co. KG, Renningen (DE); Robert Bosch GmbH, Stuttgart (DE)

(72) Inventors: Till BECK, Heilbronn (DE); Michael KNOEDLER, Leinfelden-Echterdingen (DE); Georg WALLENSTEINER, Gemmrigheim (DE); Thorsten KREMER, Gerling (DE)

(21) Appl. No.: 18/858,545

(22) PCT Filed: Apr. 21, 2023
(86) PCT No.: PCT/EP2023/060545

§ 371 Date: Oct. 21, 2024

(30) Foreign Application Priority Data
Apr. 22, 2022 (DE) 10 2022 109 737.4

(51) Int. Cl. H01R 4/48; H01R 13/02; H01R 13/24; H01R 43/16

(52) U.S. Cl. CPC H01R 4/48; H01R 13/025; H01R 13/2414; H01R 43/16

(57) ABSTRACT

A cable or a line and a plug contour at a line end of an electric line, of a stranded wire, has the following steps. The electric line at the line end is pressed-formed to form a plug portion with at least one flat surface portion at this line end. A contact strip is formed with a plurality of resilient contact lamellae that protrude from the contact strip. The contact strip is applied and connected to the surface portion.

### CROSS-REFERENCE TO RELATED APPLICATIONS

This application is a 371 U.S. National Phase of International Application No. PCT/EP2023/060545, filed on Apr. 21, 2023 and also claims the benefit of German Application No. 10 2022 109 737.4, filed on Apr. 22, 2022. The entire disclosures of the above applications are incorporated herein by reference.

### DESCRIPTION

The disclosure relates to electric cables or electric lines provided with a plug contour for directly plugging into a plug receptacle, e.g., at a mating plug, an interface, a contact socket, or a plug.

No uniform terminology exists in the prior art for plugs and sockets or male contacts and female contacts. In the terminology of the present disclosure, either male or female contacts can be used in a plug or a socket. Male contacts are usually non-resilient contact geometries, such as contact pins, flat contacts, or the like. Female contacts are resilient contacts in which at least one resilient contact element is present which is involved in making contact with a mating contact.

A plug connection is therefore realized by means of a plug and a mating plug, the respective plugs and mating plugs optionally containing corresponding or interacting resilient contacts and non-resilient contact parts.

Furthermore, a multitude of connection solutions are known in the prior art for connecting an electric contact element to an electric line, e.g., a stranded conductor. Conventional techniques such as soldering, welding, crimping, and the like are not discussed in this disclosure, since these methods are adequately described in the prior art and addressed normatively in the IEC 60325 series of standards.

DIN EN 60352-2 contains requirements, tests, and application instructions for solderless crimp connections made with stranded wire conductors having a cross section of from 0.05 mm² to 10 mm² or with solid conductors having a diameter of from 0.25 mm to 3.6 mm and having suitable uninsulated or pre-insulated crimp sleeves.

Substantially larger cable cross sections cannot currently be easily connected to a contact element in an efficient and cost-effective manner. Not only the manufacturing technology, but also the contact geometry and contact design are complex and expensive.

The components of alternative drives in automotive engineering are increasingly being designed as plug-in components in terms of their electric contact due to their ease of assembly and serviceability. The most stringent of demands in terms of electric contact properties, load capacity, tightness, and installation space are placed on plug connections.

DE 10 2013 004 708 A1 relates to an electric stranded conductor made of copper for the parallel and/or serial contacting of round plug contacts with a line cross section, wherein at least one portion of the stranded conductor has a portion with a reduced cross section and a cylindrical round plug contact socket or a cylindrical round plug contact pin is welded to this portion.

Another significant problem in the prior art is the use of copper as a connecting material, since joining copper with a contact element by welding, as is required in the automotive industry, can be achieved only with difficulty or unreliably.

If, for example, the detachable plug contacts are made of a first material which is different from copper or comprises an alloy in which copper is only present in reduced amounts, a particular problem arises in connecting the plug contacts to the copper conductor.

In the current state of the art, crimp connections are therefore primarily used to ensure a secure connection.

It is therefore the object of the disclosure to provide a solution for establishing simple and cost-effective contact between an electric interface and an electric line.

This object is achieved by the combination of the following.

One basic idea of the disclosure is to modify a conventional electric line (cable) such that the line itself or the line end is designed as a plug contour. According to the disclosure, a method for manufacturing such a plug contour at a line end of an electric line, particularly of a stranded wire, is therefore proposed which comprises the following steps:
a. forming, in particular press-forming, the electric line at the line end to form a (preferably compacted) plug portion with at least one flat surface portion at this line end,
b. providing a contact strip (contact lamella strip), the contact strip having a plurality of resilient contact lamellae protruding from the contact strip, and
c. applying and connecting the contact strip to the surface portion.

In addition, the disclosure proposes a method for manufacturing a plug contour at a line end of an electric line, particularly of a stranded wire, comprising the following steps:
a. forming, in particular press-forming, the electric line at the line end to form a (preferably compacted) plug portion with at least one flat surface portion at this line end,
b. providing a contact strip (contact lamella strip), the contact strip having a plurality of resilient contact lamellas protruding from the contact strip, and
c. applying and connecting the contact strip to the surface portion.

In the method, at least one fastening element for a correspondingly designed mating plug is also formed in the flat surface portion and/or directly adjacent to the flat surface portion, in particular by means of forming and/or separating, more particularly punching, and/or a contact strip is provided with the at least one fastening element.

Furthermore, the term “electric line” also includes an electric conductor, such as a rigid busbar. Instead of compacting or forming an electric line, it is also conceivable according to the disclosure to use a (solid) busbar and then carry out steps b) and c) on the surface of the busbar.

The contact strip must be applied in such a way that the contact lamellae protrude on the upper side opposite the connection side and can act as resilient lamellae when plugged together with a mating plug element.

It is also preferred if the electric line has a substantially round cross-sectional shape in the adjacent non-formed region of the line adjoining the formed region. In terms of the present disclosure, “round” refers to a cross-sectional shape of typical round lines, which is not always perfectly round but approximately round.

In another advantageous embodiment of the disclosure, a provision is made that a substantially cuboid-shaped line portion is formed, preferably compacted, during forming. This should be done in such a way that the strands of the stranded conductor are locally baked and pressed together, which can be achieved in particular by means of a compaction process.

It is therefore also advantageous if the line end is processed by means of compaction and, in particular, is brought into a shape in which the plug portion is formed with a flat upper side and a flat lower side substantially parallel thereto. This provides a simple plug contour in a basic shape suitable for a plugging operation.

In another advantageous embodiment of the disclosure, a provision is made that such a contact strip is provided in which a plurality of contact lamellae arranged in parallel are provided and the contact lamella strip is applied to one of the surface portions at the line end in such a way that the parallel contact lamellae are oriented either along or transversely, in particular transversely by 90°, to the cable extension direction.

Alternatively, an embodiment is conceivable in which such a contact strip is provided in which a plurality of contact lamellae arranged in parallel are provided and the contact lamella strip is applied to one of the surface portions at the line end in such a way that the parallel contact lamellae are oriented at an angle of 30° to 60°, preferably 45°, and/or 120° to 150°, preferably 135°, to the cable extension direction (L). Such an orientation of the contact lamellae at a corresponding angle to the cable extension direction advantageously allows the electric line to be plugged in both in the cable extension direction and at 90°.

In addition to the method described, another aspect of the present disclosure also relates to an electric line, in particular to an electric stranded conductor having a line end which forms a plug portion which has at least one flat, in particular planar surface portion, and at least one contact strip applied directly to the surface portion and connected thereto, the contact strip having a plurality of (elastically) resilient contact lamellae protruding from it.

Also proposed according to the disclosure is an electric line, in particular an electric stranded conductor, comprising a line end which forms a plug portion which has at least one flat, in particular planar surface portion, and at least one contact strip applied directly to the surface portion and connected thereto, the contact strip having or possessing a plurality of (elastically) resilient contact lamellae protruding from it. Furthermore, the plug portion of the line end has at least one fastening element for a correspondingly designed mating plug. In particular, the at least one fastening element is a latching element and/or a locking element.

The advantage of this is that the fastening element provides a primary locking mechanism for the line in a simple, cost-effective and space-saving manner (particularly directly at the plug portion), which fixes it against a tear-out force acting on the line. An insulating body for the line is fastened in the correspondingly designed mating plug, in particular in a connector housing of the correspondingly designed mating plug. Alternatively, the mating plug can also form and/or encompass the insulating body. Another advantage is that no additional parts or components are required to attach the line to the mating plug. In other words: the electric line is fastened or attached, in particular primarily latched or primarily locked, directly in or on the mating plug by means of the fastening element at the line end, particularly in a detachable manner. This makes it possible for an especially compact and small, easy-to-manufacture and cost-effective plug connector consisting of a plug and mating plug to be provided.

In an advantageous embodiment of the disclosure, a provision is made that the at least one fastening element is formed in the flat surface portion and/or directly adjacent to the flat surface portion. The fastening element is particularly a recess, more particularly a groove-like recess.

The line according to the disclosure is designed in one embodiment such that at least the contact strip has at least one fastening element. Furthermore, the at least one fastening element is designed or formed or configured particularly as a spring element, a pin, and/or a bayonet joint element.

In an advantageous embodiment of the line, a provision is made that the electric line has a substantially round cross-sectional shape in the adjacent non-formed region of the line adjoining the end-side plug portion.

Another advantageous solution is one in which the contact strip has a web on the edge side in at least one edge region to which the plurality of contact lamellae are connected on one side, the other (opposite) end of the contact lamellae being designed as a free end.

The contact lamellae can be advantageously bent like a spoon tip, so that the contact point of the respective contact lamellae is located approximately in the middle of the surface portion in the direction of the contact lamella extension and the ends of the contact lamellae end on or slightly above the surface portions. To clarify the preferred lamellar profile, reference is made to the figure in the description of the exemplary embodiments.

In principle, however, other lamella shapes are also conceivable. In any case, according to the concept of the disclosure, it is advantageous if multiple, in particular 3, 4, 5, 6, or 7 lamellae are arranged next to one another.

An alternative embodiment makes a provision that two opposing surface portions are formed on the plug portion and a contact strip connected thereto is preferably applied and fastened to each surface portion. The contact lamellae can be aligned in mirror symmetry or in opposite directions.

In an advantageous embodiment of the line, a provision is also made that at least one contact strip protrudes laterally and/or frontally with an overhang beyond the outer contour of the plug portion, so that a contact or stop surface for interacting with a mating surface on a mating plug which is appropriately shaped for plugging-together is formed by the respective overhang. A defined overhang can be used to optimize the joining and mating connection with the mating plug element.

The connection of the contact strip is advantageously achieved through a material bond, especially preferably at a plurality of connection points.

The concept of the invention is especially suitable for electric lines that have a cable sheath. In the method according to the invention, the cable sheath in a defined end portion is then removed before compacting or generally forming, and the remaining cable sheath can also serve as a stop for determining the insertion depth.

A plug connector with a plug and a correspondingly designed mating plug is also proposed according to the disclosure. The plug is an electric line, in particular an electric stranded conductor, having a line end which forms a plug portion which has at least one flat surface portion, as well as at least one contact strip which is applied directly to the surface portion and connected thereto. In addition, the contact strip has a plurality of contact lamellae protruding from it which are particularly elastic and resilient. The plug portion of the line end has at least one fastening element for the correspondingly designed mating plug. Furthermore, the at least one fastening element is particularly a latching element and/or a locking element.

In an advantageous embodiment, the mating plug is formed in two parts, and respective parts of the two-part mating plug have a fixing means which complement one another. This means that the two parts of the two-part mating plug can be attached to each other.

Other advantageous refinements of the disclosure are characterized in the subclaims and/or depicted in greater detail below together with the description of the preferred embodiment of the invention with reference to the figures.

### BRIEF DESCRIPTION OF THE DRAWINGS

FIG. 1 shows a line portion according to the disclosure with a plug contour;

FIG. 2 shows an alternative embodiment of a line according to the disclosure with a plug contour;

FIG. 3 shows a frontal schematic view of a plug contour according to the disclosure;

FIG. 4 shows a top view of the embodiment analogously to FIG. 3; and

FIG. 5 shows a top and side view of an alternative contact strip;

FIG. 6a shows a perspective view of an electric line;

FIG. 6b shows a sectional view of the electric line arranged in a mating plug;

FIG. 7a shows a perspective view of another electric line;

FIG. 7b shows a sectional view of the other electric line arranged in a mating plug;

FIG. 8a shows a perspective view of yet another electric line;

FIG. 8b shows a sectional view of the yet another electric line arranged in a mating plug;

FIG. 9 shows another alternative embodiment of a line according to the disclosure with a plug contour.

The figures merely represent schematic examples. Same reference symbols in the figures indicate same functional and/or structural features.

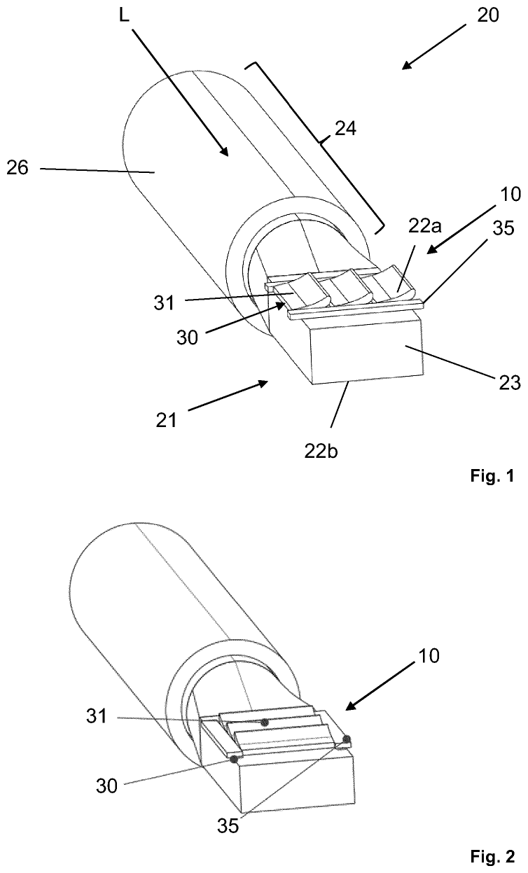

FIGS. 1 and 2 illustrate two exemplary embodiments of a pluggable line (20). Shown is a portion of an electric line 20 with the line end 23, which has a plug contour 10 and forms a plug portion 21.

The respective plug portion 21 in both FIGS. 1 has a cuboid shape and an upper and lower flat surface portion 22a, 22b which are diametrically opposed to one another.

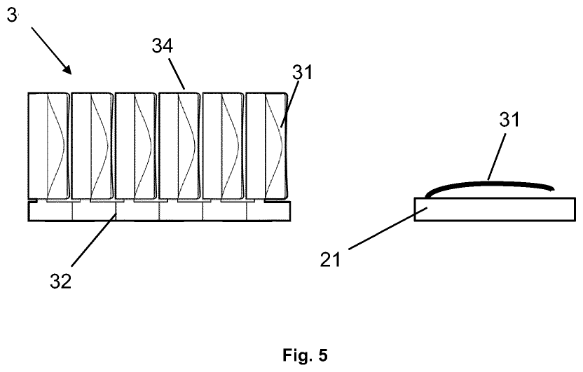

A contact strip 30 is materially bonded to the respective upper surface portion 22a and, as can be seen in FIG. 4, is connected at a plurality of materially bonded connection points. Furthermore, it can be seen that the contact strip 30 has a plurality (three in each of FIGS. 1 and 2) of (elastically) resilient contact lamellae 31 protruding from it. The contact lamellae 31 protrude upward, so that they are provided on a mating contour for resilient contact during plugging. Due to the resilient properties, a contact force is obtained which depends on the number of contact lamellae and the resilience thereof.

Furthermore, it can be clearly seen in FIGS. 1 and 2 that the electric line 20 in the adjacent non-formed region 24 of the line 20 adjoining the end-side plug portion 21 has a substantially round cross-sectional shape and is embodied with a cable sheath 26.

FIG. 5 shows an embodiment of a contact strip 30. This contact strip 30 has a web 32 on the edge side in at least one edge region to which the plurality of contact lamellae 31 are connected on one side, and the other (opposite) end 34 of the contact lamellae 31 is designed as a free end. Resilient contact arms are thus obtained which also have a shape as shown in the view shown to the side.

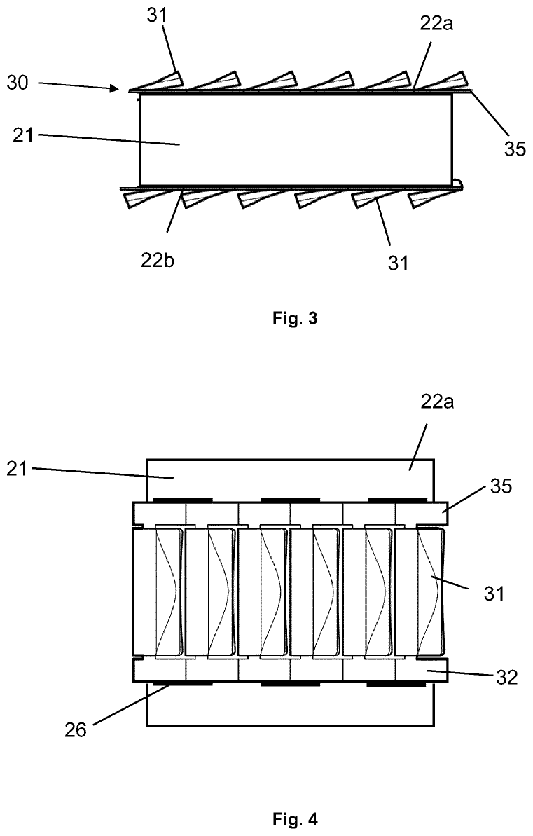

In FIG. 3, two opposing surface portions 22a, 22b are formed on the plug portion 21, and a contact strip 30 which is connected thereto is applied and fastened to each surface portion 22a, 22b, the contact lamellae 31 being arranged in opposite directions in terms of their orientation. Alternatively, mirror-inverted arrangement would also be possible. It can also be seen that the contact strip 30 protrudes laterally with an overhang 35 beyond the outer contour of the plug portion 21, so that a contact or stop surface for interacting with a mating surface on a mating plug which is appropriately shaped for plugging-together is formed by the respective overhang 35. Such a design can also be seen in FIGS. 1 and 2.

The contact strip 30 shown has a plurality of (elastically) resilient contact lamellae 31 protruding from it.

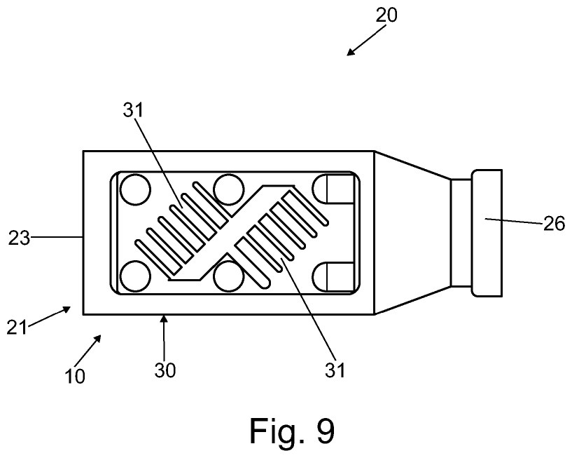

The orientation of the contact lamellae 31 in the embodiment of FIG. 1 is parallel to the line extension direction L and, in FIG. 2, extends transversely thereto at a 90° angle. Another alternative embodiment of a line 20 according to the disclosure with a plug contour 10 at the line end 23 of the line 20 is shown in FIG. 9, in which such a contact strip 30 is provided in which a plurality of contact lamellae 31 arranged in parallel are provided and the contact strip 30 is applied to one of the surface portions at the line end in such a way that the parallel contact lamellae 31 are oriented at an angle of 45° and/or 135° to the cable extension direction L.

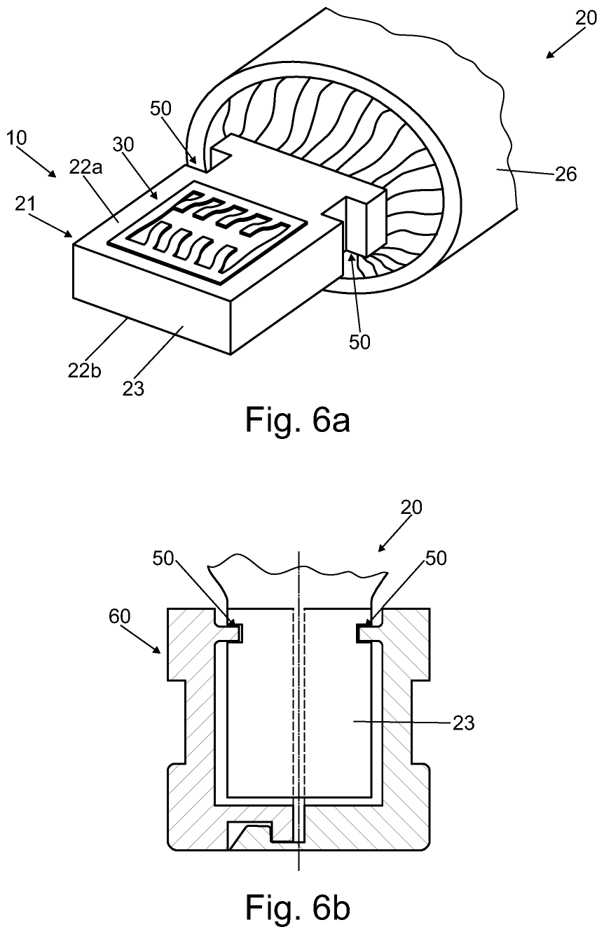

FIG. 6a shows a perspective view of an electric line 20 which is embodied as an electric stranded conductor. The electric line 20 has a line end 23 which forms a plug portion 21 having at least one flat surface portion 22a, 22b, as well as a contact strip 30 which is applied directly to the surface portion 22a, 22b and connected thereto. In addition, the contact strip 30 has a plurality of elastically resilient contact lamellae 31 protruding from it. Furthermore, the plug portion 21 of the line end 23 has two fastening elements 50 for a correspondingly designed mating plug 60. For the sake of example, the respective fastening element 50 is a latching element and/or a locking element here in the form of a groove-like punched recess. Moreover, the respective fastening element 50 is formed in the flat surface portion 22a, 22b.

FIG. 6b shows a sectional view of the electric line 20 shown in FIG. 6a arranged in a correspondingly designed mating plug 60. In the assembled state shown, the plug portion of the line 20 is completely received in the mating plug 60 and locked into the mating plug 60 with the respective fastening element 50. The mating plug is formed in two parts, and respective parts of the two-part mating plug 60 have a mutually complementary fixing means for fixing the two parts of the mating plug 60 to one another.

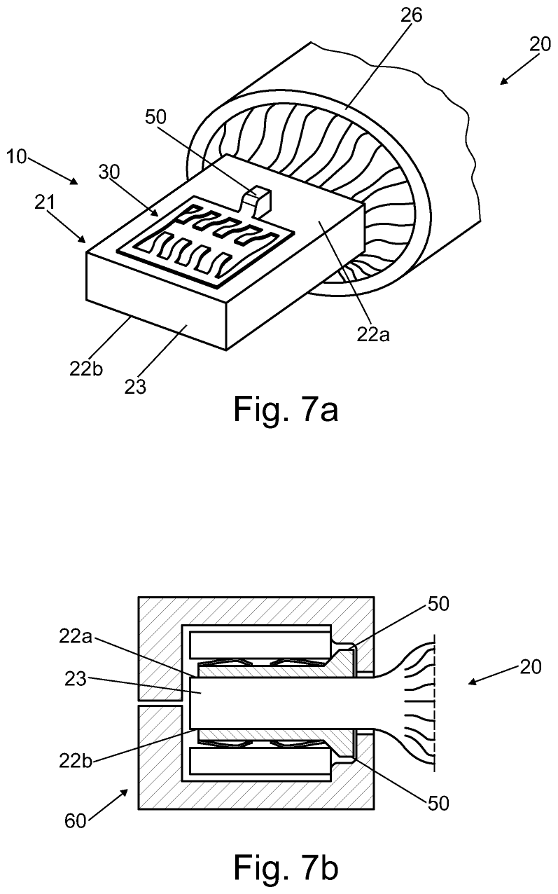

FIG. 7a shows a perspective view of another electric line 20 which is embodied as an electric stranded conductor. The electric line 20 has a line end 23 which forms a plug portion 21 having at least one flat surface portion 22a, 22b, as well as a contact strip 30 which is applied directly to the surface portion 22a, 22b and connected thereto. In addition, the contact strip 30 has a plurality of elastically resilient contact lamellae 31 protruding from it. Moreover, the contact strip 30 has a fastening element 50. The fastening element 50 is embodied here, for example, as a pin and/or bayonet locking element protruding from the one flat portion 22a.

FIG. 7b shows a sectional view of the other electric line 20 shown in FIG. 7a arranged in a correspondingly designed mating plug 60. According to FIG. 7b, a corresponding contact strip 30 with a corresponding fastening element 50 is also arranged on the other flat portion 22. In the assembled state shown, the plug portion of the line 20 is completely received in the correspondingly designed mating plug 60 and locked into the mating plug 60 with the respective fastening element 50. The mating plug is formed in two parts, and respective parts of the two-part mating plug 60 have a mutually complementary fixing means for fixing the two parts of the mating plug 60 to one another.

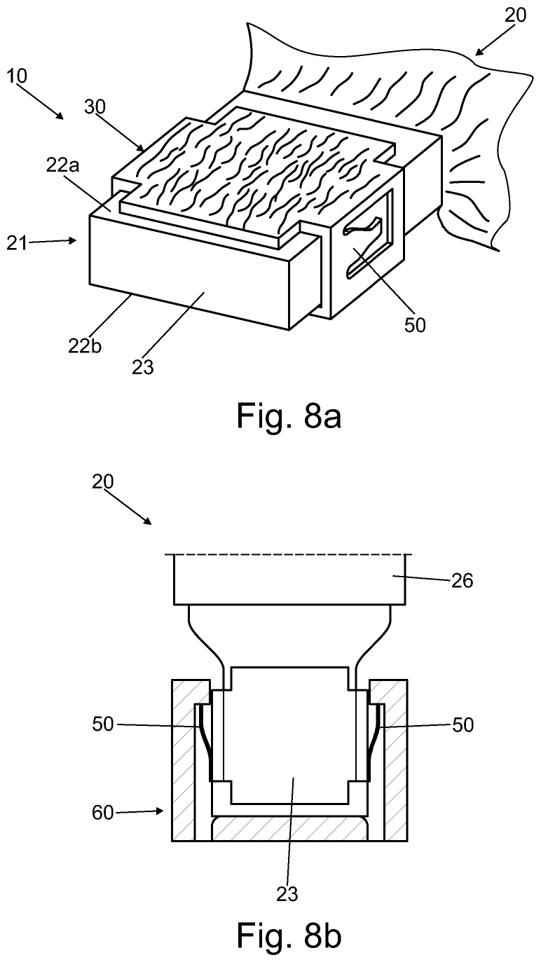

FIG. 8a shows a perspective view of yet another electric line 20, which is embodied as an electric stranded conductor. The electric line 20 has a line end 23 which forms a plug portion 21 having at least one flat surface portion 22a, 22b, as well as a contact strip 30 which is applied directly to the surface portion 22a, 22b and connected thereto. In addition, the contact strip 30 has a plurality of elastically resilient contact lamellae 31 protruding from it. Furthermore, the contact strip 30 has a fastening element 50 which extends from the flat surface portion 22a in a transverse direction of the line 20 beyond the respective side edge of the line end 23 along a side surface of the line end 23. In the area of the side surface of the line end, the fastening element has a spring element which protrudes from the side wall of the line end.

FIG. 8b shows a sectional view of the other electric line 20 shown in FIG. 8a arranged in a correspondingly designed mating plug 60. In the assembled state shown, the plug portion of the line 20 is completely received in the mating plug 60 and locked with the respective fastening element 50 in the correspondingly designed mating plug 60, which has for this purpose at least one correspondingly designed projection and/or stop and/or undercut for the fastening element 50, in particular the respective spring element.

1-20. (canceled)

21. A method for manufacturing a plug contour at a line end of an electric line, particularly of a stranded wire insert red from claim 29, comprising the following steps:
a. forming, in particular press-forming, the electric line at the line end to form a plug portion with at least one flat surface portion at this line end;
b. providing a contact strip, the contact strip having a plurality of resilient contact lamellae protruding from the contact strip; and
c. applying and connecting the contact strip) to the surface portion.

22. A method for manufacturing a plug contour at a line end of an electric line, particularly of a stranded wire, comprising the following steps:
a. forming, in particular press-forming, the electric line at the line end to form a plug portion with at least one flat surface portion at this line end;
b. providing a contact strip, the contact strip having a plurality of resilient contact lamellae protruding from the contact strip; and
c. applying and connecting the contact strip to the surface portion,
wherein furthermore at least one fastening element, for a correspondingly designed mating plug, is formed in the flat surface portion and/or directly adjacent to the flat surface portion, in particular by of forming and/or separating, and/or wherein the contact strip is provided with the at least one fastening element for the correspondingly designed mating plug.

23. The method according to claim 21, wherein the electric line represents a busbar, in particular a solid busbar, and steps b) and c) are carried out on the surface of the busbar under omission of step a).

24. The method according to claim 21, wherein the electric line has a substantially round cross-sectional shape in the adjacent non-formed region of the line adjoining the formed region.

25. The method according to claim 23, characterized in that a substantially cuboid-shaped line portion is formed during the forming process.

26. The method according to claim 21, wherein the line end is processed by compaction and, in particular, is brought into a shape wherein the plug portion is formed with a flat upper side and a flat lower side substantially parallel thereto.

27. The method according to claim 21, wherein such a contact strip is provided where a plurality of contact lamellae arranged in parallel are provided and the contact lamella strip is applied to one of the surface portions at the line end in such a way that the parallel contact lamellae are oriented either along or transversely, in particular transversely by 90°, to the cable extension direction (L).

28. The method according to claim 21, wherein such a contact strip is provided where a plurality of contact lamellae arranged in parallel are provided and the contact lamella strip is applied to one of the surface portions at the line end in such a way that the parallel contact lamellae are oriented at an angle of 30° to 60°, preferably 45°, and/or 120° to 150°, preferably 135°, to the cable extension direction (L).

29. An electric line, in particular an electric stranded conductor having a line end with a plug contour, which line end forms a plug portion which has at least one flat surface portion, as well as at least one contact strip applied directly to the surface portion and connected thereto, wherein the contact strip has a plurality of (elastically) resilient contact lamellae protruding from it.

30. An electric line, in particular an electric stranded conductor having a line end with a plug contour, which line end forms a plug portion which has at least one flat surface portion, as well as at least one contact strip applied directly to the surface portion and connected thereto, wherein the contact strip has a plurality of contact lamellae has a plurality of contact lamellae protruding from it which are particularly elastic and resilient, wherein the plug portion of the line end has at least one fastening element for a correspondingly designed mating plug, wherein, in particular, the at least one fastening element is a latching element and/or a locking element.

31. The electric line according to claim 30, wherein the at least one fastening element is formed in the flat surface portion and/or directly adjacent to the flat surface portion, wherein the fastening element is in particular a recess, more particularly a groove-like recess.

32. The electric line according to claim 30, wherein the at least one contact strip has the at least one fastening element, wherein the at least one fastening element is a spring element, a pin, and/or a bayonet joint element.

33. The electric line according to any one of claim 29, wherein the electric line has a substantially round cross-sectional shape in the adjacent non-formed region of the line adjoining the end-side plug portion.

34. The electric line according to claim 29, wherein the contact strip has a web on the edge side in at least one edge region to which the plurality of contact lamellae are connected on one side, the other (opposite) end of the contact lamellae being embodied as a free end.

35. The electric line according to claim 29, wherein that two opposing surface portions are formed on the plug portion, and a contact strip connected thereto is applied and fastened to each surface portion.

36. The electric line according to claim 29, wherein that at least one contact strip protrudes laterally and/or frontally with an overhang beyond the outer contour of the plug portion, so that a contact or stop surface for interacting with a mating surface on a mating plug which is appropriately shaped for plugging-together is formed by the respective overhang.

37. The electric line according to claim 29, characterized in that the line has a cable sheath.

38. A method for manufacturing a plug contour at a line end of an electric line, particularly of a stranded wire conductor having a line end with a plug contour, which line end forms a plug portion which has at least one flat surface portion, as well as at least one contact strip applied directly to the surface portion and connected thereto, wherein the contact strip has a plurality of (elastically) resilient contact lamellae protruding from it, comprising the following steps:
a. forming, in particular press-forming, the electric line at the line end to form a plug portion with at least one flat surface portion at this line end;
b. providing a contact strip, the contact strip having a plurality of resilient contact lamellae protruding from the contact strip; and
c. applying and connecting the contact strip) to the surface portion.

39. A plug connector with a plug and a correspondingly designed mating plug, the plug being an electric line, in particular an electric stranded conductor, having a line end which forms a plug portion which has at least one flat surface portion, as well as at least one contact strip applied directly to the surface portion and connected thereto, wherein the contact strip has a plurality of contact lamellae has a plurality of contact lamellae protruding from it which are particularly elastic and resilient, wherein the plug portion of the line end has at least one fastening element for the correspondingly designed mating plug, wherein, the at least one fastening element is a latching element and/or a locking element.

40. The plug connector according to claim 39, wherein the mating plug is formed in two parts, wherein respective parts of the two-part mating plug have fixing means which complement one another.
